(19) United States
(12) Patent Application Publication
(10) Pub. No.: US 2003/0037735 A1
(43) Pub. Date: Feb. 27, 2003

(54) Animal collar system

(76) Inventors: Thomas S. Albers, Kent, OH (US); Angela L. Albers, Kent, OH (US)

Correspondence Address: Michael S. Neustel, Suite No. 4, 2534 South University Drive, Fargo, ND, 58103, US

(21) Appl. No.: 10/211,777

(22) Filed: Aug. 1, 2002

Related U.S. Application Data
(60) Provisional application No. 60/312,613, filed on Aug. 16, 2001.

(51) Int. Cl. A62B 35/00

(52) U.S. Cl. 119/863

(57) ABSTRACT

An animal collar system for safely and conveniently limiting physical movement of an animal's head. The animal collar system includes an elongate protective member having a first end and a second end. The protective member has a generally broad cylindrical structure and is preferably comprised of a resilient material such as foam material. A plurality of cutouts preferably extend into an inner section of the protective member for facilitating bending of the protective member. A securing strap is attached to the first end of the protective member and removably securable to the second end.

### CROSS REFERENCE TO RELATED APPLICATIONS

I hereby claim benefit under Title 35, United States Code, Section 119(e) of United States provisional patent application Serial No. 60/312,613 filed Aug. 16, 2001. The No. 60/312,613 application is currently pending. The No. 60/312,613 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to pet collars and more specifically it relates to an animal collar system for safely and conveniently limiting physical movement of an animal's head.

2. Description of the Related Art

Pet restraint collars have been in use for years. Pet restraint collars are commonly utilized for preventing animals from accessing wounds, sutures, and intravenous lines. Pet restraint collars are further utilized to provide safer examination of an animal by a veterinarian or grooming. Pet restraint collars further reduce aggression against other animals and prevent rubbing of eyes and ears.

An “Elizabeth collar” is a commonly utilized pet restraint collar which is comprised of a conical shaped structure formed from a rigid material. The narrow open end of the Elizabeth collar is secured about the neck of the animal behind the head and the broader open end extends forwardly about the side of the animal's head. The Elizabeth collar is relatively uncomfortable for an animal because of the rigid and relatively thin material utilized. In addition, the Elizabeth collar is bulky and awkward for the animal to wear during movement of the animal.

Another type of restraint collar is often times referred to as a “bite-not collar” which is basically a high-necked collar that prevents an animal from turning their head to bite. These types of collars are typically uncomfortable for the animal and require various lengths to accommodate the various neck lengths of animals.

Examples of patented devices which may be related to the present invention include U.S. Pat. No. 4,476,814 to Miller; U.S. Pat. No. 6,244,222 to Bowen; U.S. Pat. No. 6,129,054 to Campbell; U.S. Pat. No. 5,133,295 to Lippincott; U.S. Pat. No. 6,044,802 to Schmid et al.; and U.S. Pat. No. 418,636 to Marconi, Jr.

While these devices may be suitable for the particular purpose to which they address, they are not as suitable for safely and conveniently limiting physical movement of an animal's head. Conventional pet restraint collars are difficult to utilize and are not comfortable for animals.

In these respects, the animal collar system according to the present invention substantially departs from the conventional concepts and designs of the prior art, and in so doing provides an apparatus primarily developed for the purpose of safely and conveniently limiting physical movement of an animal's head.

### BRIEF SUMMARY OF THE INVENTION

In view of the foregoing disadvantages inherent in the known types of animal collars now present in the prior art, the present invention provides a new animal collar system construction wherein the same can be utilized for safely and conveniently limiting physical movement of an animal's head.

The general purpose of the present invention, which will be described subsequently in greater detail, is to provide a new animal collar system that has many of the advantages of the animal collars mentioned heretofore and many novel features that result in a new animal collar system which is not anticipated, rendered obvious, suggested, or even implied by any of the prior art pet restraint collars, either alone or in any combination thereof.

To attain this, the present invention generally comprises an elongate protective member having a first end and a second end. The protective member has a generally broad cylindrical structure and is preferably comprised of a resilient material such as foam material. A plurality of cutouts preferably extend into an inner section of the protective member for facilitating bending of the protective member. A securing strap is attached to the first end of the protective member and removably securable to the second end.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an animal collar system that will overcome the shortcomings of the prior art devices.

A second object is to provide an animal collar system for safely and conveniently limiting physical movement of an animal's head.

Another object is to provide an animal collar system that fits various lengths and sizes of animal necks.

An additional object is to provide an animal collar system that may be utilized upon various animals including but not limited to dogs and cats.

A further object is to provide an animal collar system that is easy to install upon an animal.

Another object is to provide an animal collar system that is comfortable for an animal.

A further object is to provide an animal collar system that does not engage objects within a home.

Another object is to provide an animal collar system that may be utilized as a floatation and safety device.

A further object is to provide an animal collar system that allows veterinarians or caregivers to feed, perform medical procedures, and dispense medication to the animal.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a cross sectional view taken along line 2-2 of FIG. 1.

FIG. 3 is a cross sectional view taken along line 2-2 with the securing strap secured.

FIG. 4 is an upper perspective view of the present invention attached about the neck of a dog.

FIG. 5 is an upper perspective view of the present invention partially attached about the neck of a dog with the securing strap removed.

FIG. 6 is an upper perspective view of the present invention with the securing strap secured.

FIG. 7 is an upper perspective view of an alternative embodiment of the present invention disclosing a shield member that blocks the animal's vision.

### DETAILED DESCRIPTION OF THE INVENTION

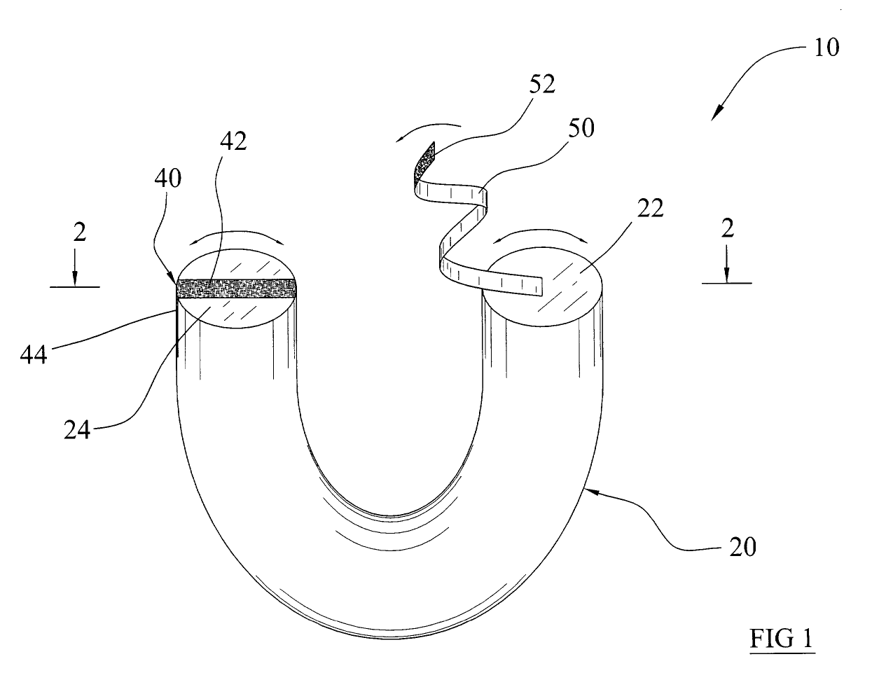

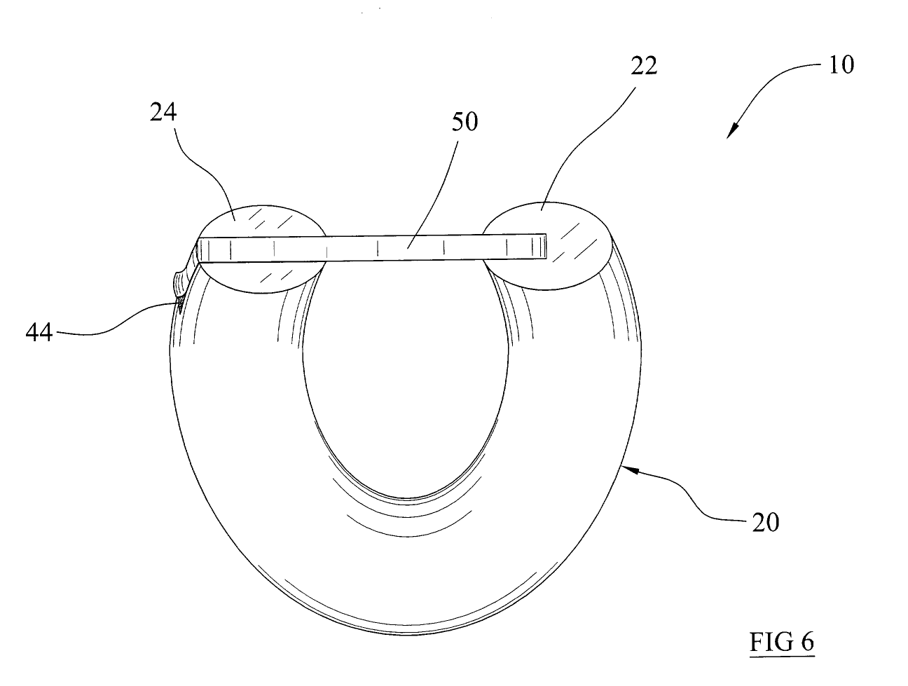

Turning now descriptively to the drawings, in which similar reference characters denote similar elements throughout the several views, FIGS. 1 through 7 illustrate an animal collar system 10, which comprises an elongate protective member 20 having a first end 22 and a second end 24. The protective member 20 has a generally broad cylindrical structure and is preferably comprised of a resilient material such as foam material. A plurality of cutouts preferably extend into an inner section of the protective member 20 for facilitating bending of the protective member 20. A securing strap 50 is attached to the first end 22 of the protective member 20 and removably securable to the second end 24.

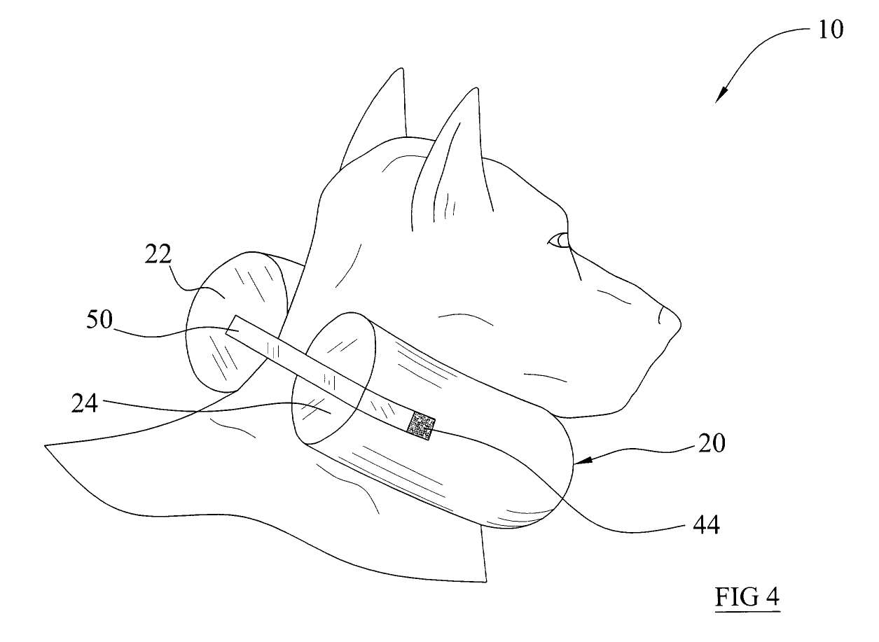

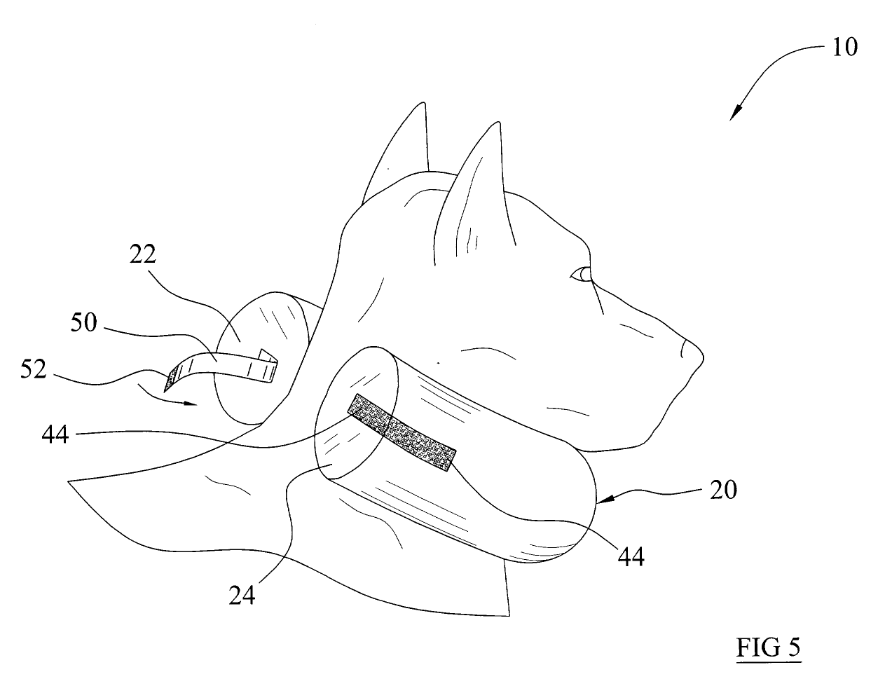

The protective member 20 is comprised of an elongate material have a relatively broad structure as shown in FIGS. 1 through 7 of the drawings. The protective member 20 has a first end 22 and a second end 24. The length of the protective member 20 is preferably sufficient to at least partially surround the neck of an animal as shown in FIGS. 4 and 5 of the drawings. The protective member 20 preferably has a circular cross section, however various other cross sectional shapes may be utilized for the protective member 20 such as but not limited oval, square, circular, semi-circular, elliptical, rectangular, flat, triangular, oblong, serrated, corrugated and the like. The size of the protective member 20 is preferably sufficient to limit the movement of the neck and head of the animal.

The protective member 20 is preferably comprised of a flexible and resilient material such as but not limited to a foam material. The applicant has found that foam rubber provides suitable physical qualities for constructing the protective member 20. Various other materials may be utilized to construct the protective member 20 such as but not limited to pliant plasticized materials, STRYOFOAM, ethafoam, flexible rubberized or polymer products, and textile. In addition, the foam material typically provides a buoyancy to the protective member 20 and the animal.

A cover 26 preferably surrounds the resilient material. The cover 26 is preferably comprised of a breathable material, however a non-breathable material may be utilized. The cover 26 is also preferably comprised of a stretchable material, however a non-stretchable material may also be utilized.

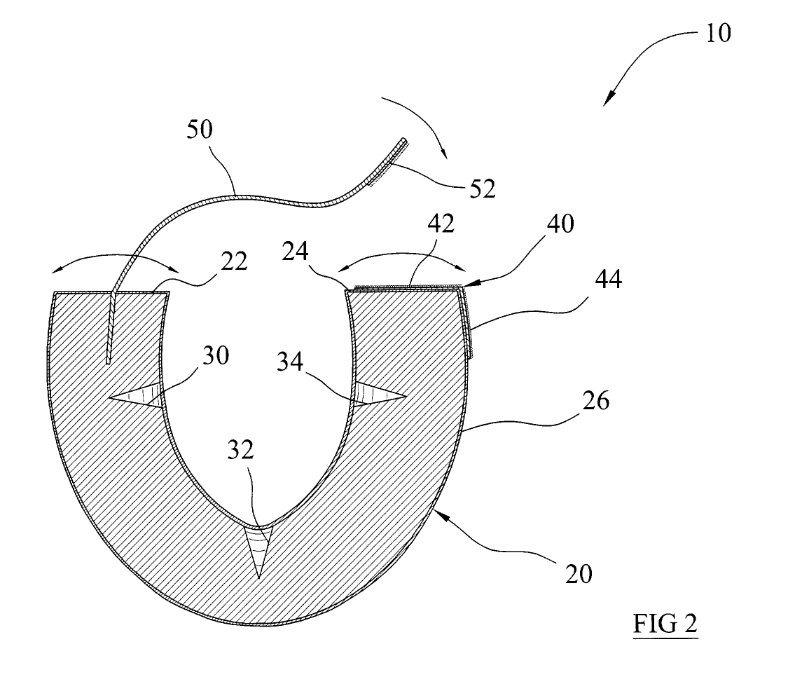

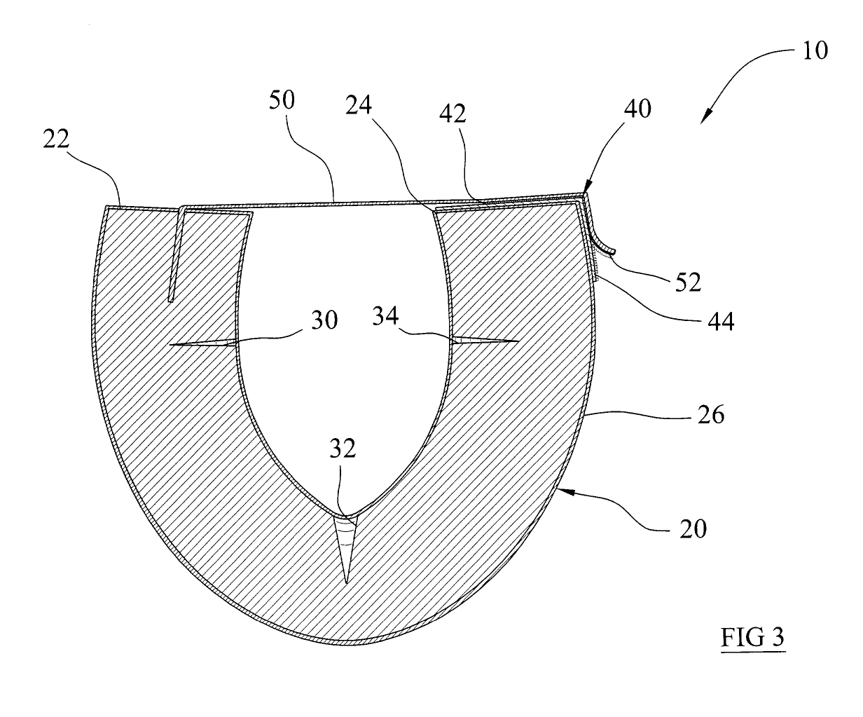

As best shown in FIGS. 2 and 3 of the drawings, a plurality of cutouts 30, 32, 34 extend into an inner section of the protective member 20 to allow for easy bending of the protective member 20 about the neck of the animal. The cutouts 30, 32, 34 are preferably comprised of a tapered structure as shown in FIG. 2 of the drawings, however various other structures may be utilized to construct the cutouts. One or more cutouts may be utilized within the present invention at various locations. The applicant has found that it is desirable to have a first cutout 30 and third cutout 34 near the opposing ends of the protective member 20 with a second cutout 32 centrally positioned within as best shown in FIG. 2 of the drawings.

As shown in FIGS. 1 through 6 of the drawings, a securing strap 50 is attached at one end to the first end 22 of the protective member 20. The securing strap 50 is comprised of a length of flexible or rigid material that is capable of extending between the first end 22 and the second end 24 of the protective member 20 about the neck of the animal as shown in FIG. 4 of the drawings.

A first fastener 40 is attached to the second end 24 of the protective member 20 for selectively receiving a second fastener 52 attached to the distal end of the securing strap 50. The first fastener 40 is preferably comprised of a first section 42 extending along the second end 24 and a second section 44 extending along the outer portion of the protective member 20 along the protective member 20 as best shown in FIG. 2 of the drawings. The fasteners 40, 52 are preferably comprised of a hook and loop fastener structure, however various other fastener structures commonly utilized may also be used.

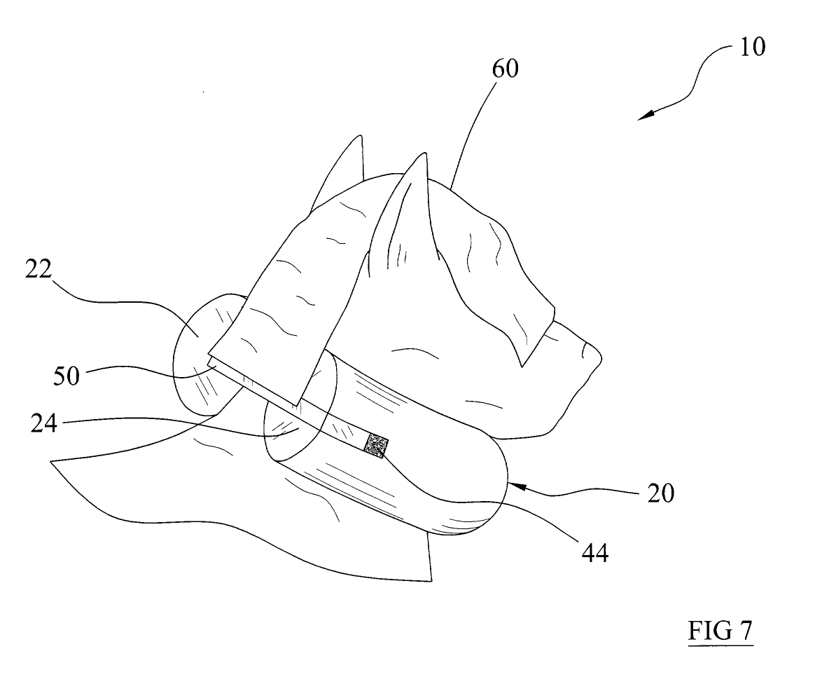

In an alternative embodiment shown in FIG. 7 of the drawings, a shield member 60 is attached to the securing strap 50. The shield member 60 is preferably comprised of a sheet of textile or plastic to allow for the selective covering of the animal's eyes. Alternative variations of the present invention may also include reflective straps added to the protective member 20 for increasing visibility of the animal during darkness.

In use, the user positions the protective member 20 about the lower portion of the neck of the animal as shown in FIG. 5 of the drawings. The user then bends the protective member 20 about the neck of the animal without engaging the animal significantly or interfering with the breathing of the animal. During the bending of the protective member 20, the cutouts 30, 32, 34 are closed for allowing the protective member 20 to be easily bent inwardly forming a curved structure. The user then secures the securing strap 50 to the second end 24 of the protective member 20 so that the protective member 20 is maintained in a relatively tight position about the neck of the animal as shown in FIG. 4 of the drawings. The animal is thereafter limited in its ability to move its head while the protective member 20 is attached to the neck of the animal. When finished with the present invention, the user removes the securing strap 50 from the second end 24 of the protective member 20 and then removes the protective member 20 from the neck of the animal.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Index of Elements for Animal Collar System

□ ENVIRONMENTAL ELEMENTS
□
□
□
□
□
□
□
□
□
□ 10. Animal Collar System
□ 11.
□ 12.
□ 13.
□ 14.
□ 15.
□ 16.
□ 17.
□ 18.
□ 19.
□ 20. Protective Member
□ 21.
□ 22. First End
□ 23.
□ 24. Second End
□ 25.
□ 26. Cover
□ 27.
□ 28.
□ 29.
□ 30. First Cutout
□ 31.
□ 32. Second Cutout
□ 33.
□ 34. Third Cutout
□ 35.
□ 36.
□ 37.
□ 38.
□ 39.
□ 40. First Fastener
□ 41.
□ 42. First Section
□ 43.
□ 44. Second Section
□ 45.
□ 46.
□ 47.
□ 48.
□ 49.
□ 50. Securing Strap
□ 51.
□ 52. Second Fastener
□ 53.
□ 54.
□ 55.
□ 56.
□ 57.
□ 58.
□ 59.
□ 60. Shield Member
□ 61.
□ 62.
□ 63.
□ 64.
□ 65.
□ 66.
□ 67.
□ 68.
□ 69.
□ 70.
□ 71.
□ 72.
□ 73.
□ 74.
□ 75.
□ 76.
□ 77.
□ 78.
□ 79.

We claim:

1. An animal collar system, comprising:
a protective member having an elongate structure, a first end and a second end;
a securing strap attached to a first end of said protective member;
a first fastener attached to said second end of said protective member; and
a second fastener attached to said securing strap for selectively engaging said first fastener.

2. The animal collar system of claim 1, wherein said protective member includes at least one cutout within an inner section.

3. The animal collar system of claim 2, wherein said at least one cutout is comprised of a tapered structure.

4. The animal collar system of claim 1, wherein said protective member is comprised of a foam material.

5. The animal collar system of claim 1, wherein said protective member is comprised of a foam rubber material.

6. The animal collar system of claim 1, wherein said protective member includes a cover.

7. The animal collar system of claim 1, wherein said first fastener and said second fastener are comprised of a hook and loop structure.

8. The animal collar system of claim 7, wherein said first fastener is comprised of a first section attached to said second end of said protective member and a second section attached along an outer side of said protective member.

9. The animal collar system of claim 1, wherein said protective member has a circular cross sectional shape.

10. The animal collar system of claim 1, wherein said protective member is comprised of a buoyant material.

11. The animal collar system of claim 1, including a shield member attached to said securing strap.

12. The animal collar system of claim 11, wherein said protective member includes at least one cutout within an inner section.

13. The animal collar system of claim 12, wherein said at least one cutout is comprised of a tapered structure.

14. The animal collar system of claim 11, wherein said protective member is comprised of a foam material.

15. The animal collar system of claim 11, wherein said protective member is comprised of a foam rubber material.

16. The animal collar system of claim 11, wherein said protective member includes a cover.

17. The animal collar system of claim 11, wherein said first fastener and said second fastener are comprised of a hook and loop structure.

18. The animal collar system of claim 17, wherein said first fastener is comprised of a first section attached to said second end of said protective member and a second section attached along an outer side of said protective member.

19. The animal collar system of claim 11, wherein said protective member has a circular cross sectional shape.

20. The animal collar system of claim 11, wherein said protective member is comprised of a buoyant material.
